(19) United States
(12) Patent Application Publication
(10) Pub. No.: US 2005/0219063 A1
(43) Pub. Date: Oct. 6, 2005

(54) Bandwidth wireline data transmission system and method

(75) Inventors: Raman Viswanathan, Houston, TX (US); Randy Gold, Houston, TX (US)

Correspondence Address: MADAN, MOSSMAN & SRIRAM, P.C., 2603 AUGUSTA, SUITE 700, HOUSTON, TX, 77057, US

(73) Assignee: Baker Hughes Incorporated, Houston, TX (US)

(21) Appl. No.: 11/086,944

(22) Filed: Mar. 22, 2005

Related U.S. Application Data
(63) Continuation-in-part of application No. 09/586,130, filed on Jun. 2, 2000, now abandoned.
(60) Provisional application No. 60/193,098, filed on Mar. 30, 2000.

(51) Int. Cl. G01V 3/00

(52) U.S. Cl. 340/854.9

(57) ABSTRACT

A suspended well logging apparatus is provided having downhole well data acquired by a sensor, transmitted to the surface via complementary modems, and conveyed to the surface modem via a data transmission cable linking the modems, the cable having at least one twisted pair of signal conductors positioned within an outer protective sheath, each of the conductors being separately insulated, the at least one twisted pair of signal conductors having a twist rate of at least ⅙ twist per inch, an insulation sheath surrounding the twisted pair of conductors and a tensile load carrier surrounding the insulation sheath, the load carrier comprising a sheath of tensile load carrying filaments enabling self support of the well logging cable.

### CROSS-REFERENCE TO RELATED APPLICATIONS

This application is a continuation-in-part of U.S. application Ser. No. 09/586,130 filed on Jun. 2, 2000, now abandoned, which application took priority from U.S. Provisional Application No. 60/193,098 titled “Improved Bandwidth Wireline Data Transmission System and Method” filed on Mar. 30, 2000, the entire specification of each application being hereby incorporated herein by reference.

### BACKGROUND OF THE INVENTION

1. Field of the invention

This invention pertains to data communications and particularly to data communications on a wireline such as one employed in an oil or gas well borehole application.

2. Description of the Prior Art

It is common in an oil or gas well borehole application to transmit and receive electrical digital data and control signals between surface electronics and downhole electronics package via a wireline of one or more conductors connecting the two. Such signals are typically used to remotely control the functions of various downhole devices such as sensors for detecting borehole parameters as well as tools and devices for performing functional operations in the borehole such as setting equipment or operating testers, motors, directional drilling equipment or the like, which may be operable in stages and in any event requiring a plurality of differing control signals at different times. Likewise, it is desirable to transmit information indicative of the operation of the downhole devices or parameters detected or measured downhole, to the surface over the same conductor path. It is customary in such downhole operations to utilize a sheathed or armored cable which includes either a single conductor or multiple conductors. A single conductor armored cable typically includes a single insulated conductor as a core, and a protective conductive sheathing surrounds the insulated core. The core and sheathing form an electrical circuit path for transmitting electrical power and data. The standard multi-conductor armored cable is a 7-conductor armored cable used for multiple channel tools. Such so called single conductor wireline cables, or similarly constructed multi-conductor cables, are almost exclusively used to operate downhole electrical devices because of a variety of reasons associated with the space limited and rigorous environment of a borehole. In such oil and gas borehole operations, a borehole depth of many thousands of feet is not uncommon. In communicating between the surface and downhole in a borehole over a wireline cable, control signals and data signals are normally converted to digital signals transmitted by a transmitter at rates up to a maximum of 20 Kbits/second. A receiver on the other end of the cable receives the signals, and a processor decodes the signals for further use.

The transmission and receiver scheme described above operates well when the rate of transmission does not exceed about 20 Kbits/second or the wireline is relatively short. However, the wireline transmission medium does cause a problem when the transmission is over a relatively long length or as the data rate increases. That is, the detection and distinguishing of the two voltage levels associated with the digital signal is impaired by distortions caused by the medium. Distortions become more acute for faster bit rates, where the periods at each of the two voltage levels are very short. For example, the frequency characteristic of a typical single conductor wireline used for downhole application has a loss of about −20 db at 5.6 Khz for a 30,000 foot length. At higher frequencies, the loss is significantly greater.

Often, multi-conductor cables are used when multiple channels to several sensors are used. The most commonly used cable today is a 7-conductor armored logging cable. For comparison purposes, a cable of at least 30,000 feet in length wherein the cable is a 7-conductor cable provided within an armored logging cable having a nominal size of 7/16 inches has a frequency bandwidth of 90 to 270 Khz. Bandwidth is defined as the frequency at which an input signal is attenuated to the point where the signal cannot be effectively recovered by the receiving device. Typically, and for the purposes of this disclosure, the attenuation is −60 db.

Today, while the wells become deeper, the measuring devices have also become more complex. That is, they provide data at a much greater rate. Moreover, the advent of digital computers installed at the well head measuring equipment has enabled the handling of greater volumes of data in a more effective fashion. All of this has occurred simultaneously increasing the requirements on the logging cable. The cables have become more complex i.e., they have added conductors, and the band pass requirements for the conductors have been increased. Still, the cables used today are unable to provide bandwidth in deep wells matching the transmission capabilities of the instrumentation.

There are several factors affecting the bandwidth of a particular cable configuration including resistance (R), capacitance (C), inductance (L) and conductance (or leakage.) Typically gains to be achieved in inductance and conductance are small since these factors are negligible. The most straightforward correction for high resistance of a cable, which is proportional to the diameter cable conductors, is to have larger diameter cables. This correction is opposed by the need to balance cable size with borehole parameters. Parameters such as borehole diameter and fluid pressure lead designers to smaller diameter cables. Capacitance of logging cables has been minimized, thereby increasing bandwidth, by adding conductors or by using a coaxial cable. As discussed earlier, the coaxial cable is used by referencing a signal to the shield (or armor.) Although capacitance is improved, the capacitances of typical coaxial and multi-conductor cables are still around 40 to 60 pF/ft.

Surface communication cables often utilize twisted pairs of conductors to increase bandwidth over single conductor transmission cables. The term twisted pair conductor, as used herein is defined as two electrically-conductive wires, which are electrically insulated from each other and twisted about each other at a given non-zero twist rate. Twisted pair conductors have heretofore been used in downhole applications only with the aide of supporting clamps or structures. One example of a clamped system is U.S. Pat. No. 6,206,133 for “Clamped receiver array using tubing conveyed packer elements”. Another example is U.S. Pat. No. 6,580,751 to Gardner, et al. for “High speed downhole communications network having point to multi-point orthogonal frequency division multiplexing.” The '133 patent describes a geophone array permanently or semi-permanently installed within a well borehole and communicating with a surface computer over twisted wire pairs. Such arrays as described in the '133 and '751 patents are not wireline systems and are unsuitable for self-supporting wireline logging in the drilling phase due to the need quickly insert the wireline data logger into a well borehole, take measurements and then remove the wireline all during a tripping cycle of the drill string.

One problem with implementing twisted pair conductors in a self-supporting wireline is stress induced at each twist crossing point causes conductor deformation or failure at the crossing point when high tensile loads are supplied. Therefore, prior wireline systems are typically designed to a standard wireline cable using single conductors or systems are designed with complicated clamping measures to secure and support the cable during use. An example of a standard wireline cable is described in U.S. Pat. No. 3,259,675 to Bowers for “Method of Manufacturing Armored Cables”. The '675 patent describes a typical 7-conductor wireline cable, which includes a central conductor surrounded by six outer insulated conductors. While the outer conductors are helically wound, they are not twisted pairs as the term is known to those in the art and as the term is used herein.

To address some of the deficiencies described above, the present invention provides a load bearing cable having improved bandwidth and lower capacitance per foot for use in wireline applications. This invention also provides a multi-conductor load bearing cable used in a single conductor mode with lower capacitance than the typical single conductor cable used today.

Although increasing the bandwidth of a cable is necessary to improve data rate transmission, it should also be appreciated that the efficient use of the bandwidth is also required. As discussed earlier, instruments now have the capability to transmit data at rates far beyond cable capabilities. Methods of encoding data for transmission used in the telecommunication industry include Quadrature Amplitude Modulation (QAM), Carrierless Amplitude and Phase (CAP) modulation, and Discrete Multi-Tones (DMT) modulation. CAP is a modified QAM method, and DMT is the method in digital subscriber line (DSL) applications currently marketed mainly as an enhancement to internet connections. At this time, the well logging community has not taken advantage of the state of the art encoding methods. The primary driver being that the cables in current use cannot provide the bandwidth necessary to utilize these encoding methods efficiently.

To meet the demand for higher data rates, the present invention provides a system utilizing telecommunication data encoding methodologies in conjunction with a load bearing data cable having enhanced bandwidth to increase transmission data rate.

This invention also provides a method of well logging data transmission having a higher data rate.

### SUMMARY OF THE INVENTION

In general, the present invention provides a logging data transmission method and apparatus. The apparatus includes a logging cable having improved bandwidth characteristics.

In one embodiment, a suspended well logging data cable comprises an outer protective sheath and a tensile load carrier positioned within the outer protective sheath, the tensile load carrier enabling the self support of the well logging cable while suspended in a well borehole. At least one twisted pair of signal conductors is positioned within the outer protective sheath, each of the conductors being separately insulated, the at least one twisted pair of signal conductors having a twist rate of at least ⅙ twist per inch.

In another embodiment, a cable is provided having at most seven twisted pairs of conductors disposed around a center conductor and operating in a single conductor mode or in differential mode.

In one aspect, the wireline logging cable includes at most seven twisted pair signal conductors.

In one embodiment a system having an improved data transmission rate is provided comprising a downhole well data sensor and a downhole data transmitter such as a modem and an encoding method of QAM, CAP or DMT. Included in the system is a surface data receiver complementary to the downhole transmitter. A well logging cable linking the transmitter and the receiver includes an outer protective sheath, at least one twisted pair of signal conductors positioned within the outer protective sheath, each of the conductors being separately insulated, the at least one twisted pair of signal conductors having a twist rate of at least ⅙ twist per inch, an insulation sheath surrounding the at least one twisted pair of signal conductors, and a tensile load carrier surrounding the insulation sheath, the tensile load carrier comprising a sheath of tensile load carrying filaments enabling self support of the well logging cable, the downhole well data logger and the downhole transmitter while suspended in a well borehole.

In one embodiment a method of transmitting data from a well borehole to a surface location comprises transmitting the signal with a downhole data transmitter and conveying the signal on a suspended well logging cable linking the transmitter and to a surface receiver, the well logging the cable having at least one twisted pair of signal conductors positioned within an outer protective sheath, each of the conductors being separately insulated, the at least one twisted pair of signal conductors having a twist rate of at least ⅙ twist per inch, an insulation sheath surrounding the twisted pair of conductors and a tensile load carrier surrounding the insulation sheath, the load carrier comprising a sheath of tensile load carrying filaments enabling self support of the well logging cable, the downhole well data logger and the downhole transmitter while suspended in the well borehole.

### BRIEF DESCRIPTION OF THE DRAWINGS

For detailed understanding of the present invention, references should be made to the following detailed description of the preferred embodiment, taken in conjunction with the accompanying drawings, in which like elements have been given like numerals and wherein:

FIG. 1 is a cross section view of a cable according to an embodiment of the present invention;

FIG. 2A is a simulation showing attenuation as a function of frequency using the dimensional and material specifications of a cable according to an embodiment of the present invention as a starting point for the simulation;

FIG. 2B is a simulation showing attenuation as a function of frequency for a cable in accordance with an embodiment of the present invention using measured values of capacitance as the simulation input;

FIG. 2C is a simulation showing attenuation as a function of frequency using correction factors due to the effects of armor surrounding the conductors of a cable according to an embodiment of the present invention;

FIG. 3 is a cross section view of a 7-conductor cable configuration according to an embodiment of the present invention;

FIG. 4 is a schematic representation of a wireline system according to an embodiment of the present invention; and

FIGS. 5A-5C illustrate an improved twist-rate according to embodiments of the present invention.

### DESCRIPTION OF THE PREFERRED EMBODIMENTS

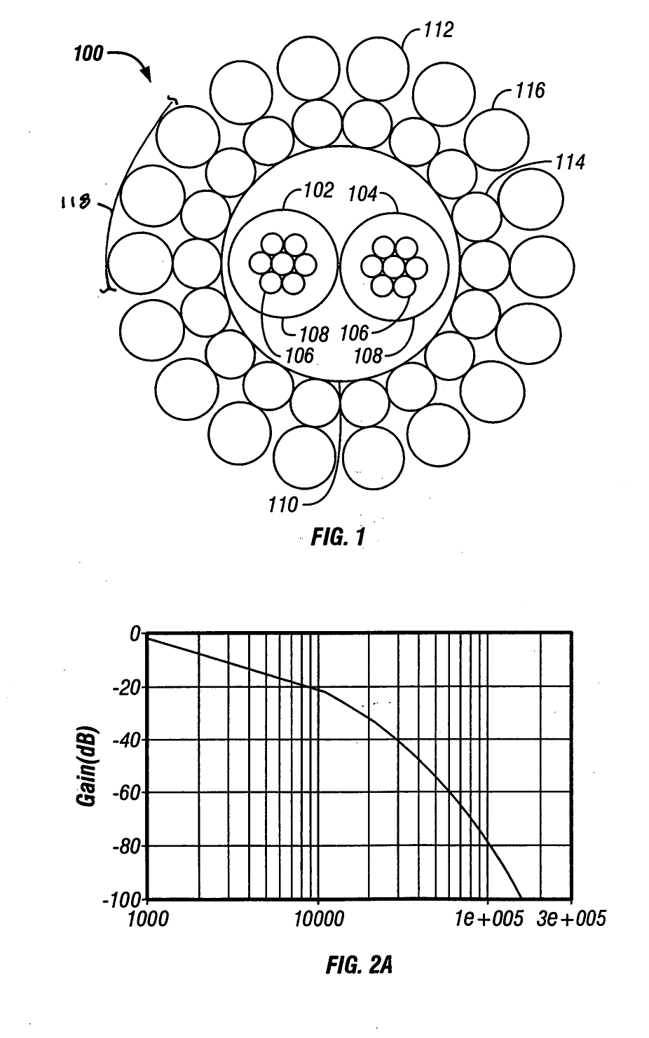

FIG. 1 is a cross section view of a suspended well logging cable according to an embodiment of the present invention. The term suspend or suspended is used as those skilled in the art of wireline would understand, which understanding is to support the wireline cable at an upper point while allowing the remainder of the structure to hang substantially free on all sides so as not to sink or fall into the well borehole. A suspended wireline logging cable 100 according to one embodiment includes a twisted pair of insulated signal conductors 102 and 104 helically twisted together and positioned along a central axis of the cable. Each of the insulated conductors 102 and 104 comprises a group of electrically conductive stranded wires 106 encased by a tightly fitted, tubular sheath of insulating material 108. The stranded wires may be copper or any other suitable metallic material, and the insulating material 108 is preferably an extrudable plastic, which maximizes electrical insulation and temperature characteristics while minimizing the insulation thickness and dielectric constant. For downhole applications, a preferred insulating material 108 is a fluorinated ethylene propylene (FEP) plastic such as one sold under the brand TEFLON®. It may also be a combination such as TEFLON® and TEFZEL® brand FEP both of which are well known insulator brands. If FEP insulation is used for a downhole data transmission application, a thickness of 0.0125″ (0.32 mm) is recommended. Power applications may require more insulation. A protective elastomer bedding 110 is disposed around the twisted pair to provide protection from abrasions and other damage due to rough handling and harsh environments.

The cable 100 includes a tensile load bearing tubing 112 comprising an inner layer 114 and an outer layer 116 of wires. The inner layer of wires 114 is a plurality of stranded structural steel wires with 0.025″ (0.64 mm) total outer diameter helically wound around the elastomer bedding 110. The outer layer 116 is a plurality of stranded structural steel wires with 0.0345″ (0.88 mm) total outer diameter helically wound around the inner layer 114. An outer protective sheath 118 may be used to protect the cable against abrasions caused by running the cable in and out of the borehole. The twisted pairs of signal conductors and the tensile load carriers will thus be within the outer protective sheath 118.

The overall outer diameter of a cable built to these dimensions would be 0.025″ (6.35 mm). The relationship between resistance and diameter of a conductor is inversely proportional and the load bearing capability is directly proportional to the diameter. These relationships would normally lead one to larger cable designs. However, the overall diameter of a cable should be minimized in a downhole application, because the pressure of the fluid in the well may force a cable out of the well if the diameter is too large.

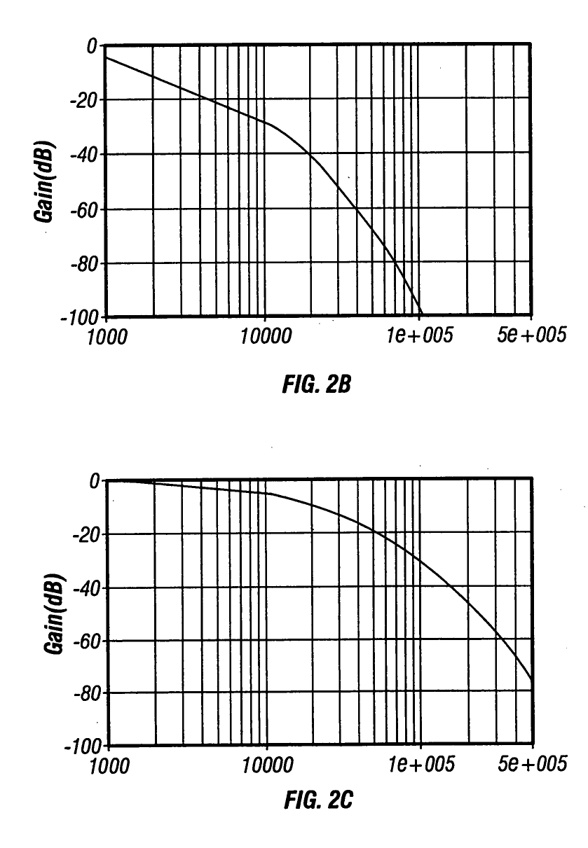

Referring now to FIG. 1 and FIGS. 2A through 2C showing bandwidth plots based a twisted pair load bearing cable as described above and shown in FIG. 1. FIG. 2A is a simulation using dimensional and material specifications of a cable as a starting point for the simulation. FIG. 2B is the same simulation using values from measurements with a capacitance meter. FIG. 2C is a simulation using correction factors due to the effects of armor 112 surrounding the conductors 102 and 104.

The most useful capacitance to know is the effective capacitance per foot (C_{eff}) of the cable. This is the effective capacitance between the conductors 102 and 104. To determine C_{eff}, equations are used that require measured values between the conductors 102 and 104 (designated as C₁₂ₘ) and between each conductor and the armor 112 (designated as C₁₃ₘ and C₂₃ₘ respectively.) The computation is initiated with an experienced based empirical value of 1 F for the same parameters, C₁₂, C₁₃ and C₂₃. To determine the actual C₁₂ or C_{eff}, equations are then set up as follows:

$$\frac{{C}_{13} \times {C}_{23}}{{C}_{13} + {C}_{23}} + {C}_{12} = {C}_{12 m} ;$$

$$\frac{{C}_{13} \times {C}_{12}}{{C}_{13} + {C}_{12}} + {C}_{13} = {C}_{13 m} ; and$$

$$\frac{{C}_{23} \times {C}_{12}}{{C}_{23} + {C}_{12}} + {C}_{23} = {C}_{23 m} .$$

The equations are then iteratively solved for the correct values of C₁₂, C₁₃, and C₂₃ yielding:
C₁₂=2.999×10-11 F/m;
C₁₃=8.999×10-11 F/m; and
C₂₃=8.999×10-11 F/m.

Therefore, since 1 m=3.28084 ft, the C_{eff} of C₁₂ for the cable described is actually 9.144 pF/ft. Compare this to the typical cable values of 40-60 pF/ft as stated above. The capacitance and conductor configuration of a cable according to the present invention results in a bandwidth of about 350 KHz.

There are two modes of operation or configuration modes useful for the twisted pair cable described above. These are the single conductor mode and the twisted pair or differential mode. In the single conductor mode, the ends of the conductors 102 and 104 are tied together electrically. A signal transmitted on the cable is then sensed with reference made to the armor 112. In the differential mode, the conductors 102 and 104 are each used independently for signal transmission, and the signal is sensed as a differential between the conductors 102 and 104. The bandwidth of either configuration is larger than the bandwidth of current single conductor load bearing cables used in well logging systems.

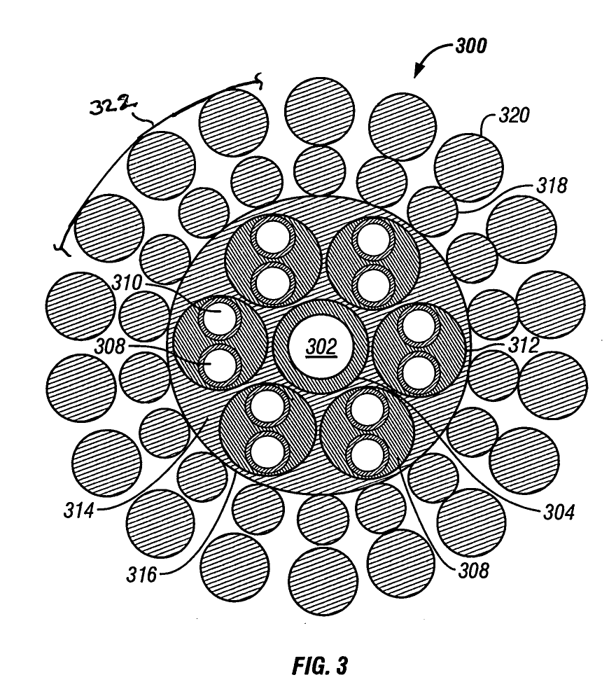

FIG. 3 is a cross section view of a 7-conductor cable configuration 300 according to the present invention. In this configuration, a core or center conductor 302 is covered in an insulation material 304 such as the extrudable TEFLON® FEP or a TEFLON®/TEFZEL® FEP combination as described above. Six twisted pair wires 306, each comprising twisted pair insulated conductors 308 and 310 as described above with respect to FIG. 1, are disposed around a circumference of the center conductor 302. The twisted pairs are also insulated as described in FIG. 1 with a protective cover 312. The center 302 and surrounding twisted pair conductors 306 are encased in an insulating dielectric material 314, several of such materials being well known in the art. Also well known in the art and not shown separately here is a plurality of fiber cords running axially the length of the cable and disposed in the dielectric material 314. These cords provide internal strength and stability to the cable to ensure the conductors are substantially fixed with respect to the internal distance between each other. Disposed circumferentially around the dielectric material 314 is an elongated tubular sheath 316, which may be a conductive paste, a plastic tape or an insulation material like well known in the art. A tensile load bearing covering comprised of an inner layer of wires 318 and an outer layer of wires 320 is disposed about the sheath 316. The inner layer of wires 318 is a plurality of stranded wires with helically wound around the sheath 316. The outer layer 320 is a plurality of stranded wires helically wound around the inner layer 318. An outer protective sheath 322 may be used be added to protect the cable against abrasions caused by running the cable in and out of the borehole. The twisted pairs of signal conductors and the tensile load carriers will thus be within the outer protective sheath 322.

In this configuration, center conductor 302 is shown as a single conductor. However, the intent is not to exclude the use of a twisted pair for the center conductor. Also, the preferable mode for the twisted pair wires is the single conductor mode where the ends are electrically connected, but the differential mode may be preferable in a particular application. As known in the art, any conductor may carry both data and power simultaneously.

Referring to FIGS. 1-3 and FIGS. 5A-C, embodiments of the present invention include a combination of tensile load carriers and twisted pairs of signal conductors twisted at a predetermined twist rate that enables self support of the wireline while minimizing deformation at the cross points of the conductors and maximizing cable capacitance characteristics to provide improved bandwidth.

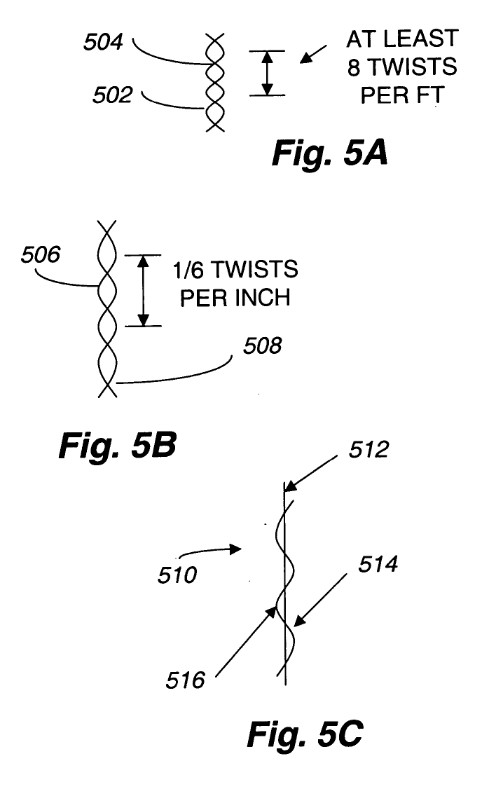

FIG. 5A shows a twisted pair of signal conductors 502 having at least 8 twists per foot. The higher twist rate allows for higher bandwidth of the cable and reduced stress at the crosspoints 504. The higher twist rate will require more conductor length per cable length unit. Added conductor length will add cost and weight to the overall cable. Therefore it may be desirable in other embodiments to reduce the twist rate.

FIG. 5B shows a twisted pair of signal conductors 506 having a minimum of ⅙ twists per inch to provide the electrical characteristic benefits of twisted pair conductors while reducing the overall length of conductors and weight of the cable. Such a minimum twist rate still maintains reduced stress at the crosspoints 508.

The twisted pair signal conductors of FIGS. 5A-5B in combination with the tensile load carriers described above and shown in FIGS. 1-3 provide a suspend wireline logging cable with improved bandwidth over known suspended wireline logging cables. Logging cable configurations according to several embodiments of the present invention are schematically illustrated in FIG. 5C. For simplicity, the figure does not illustrate the tensile load carrier of FIGS. 1 or 3, but such carrier should be implied for the purposes of the invention. A suspended wireline logging cable 510 includes a center conductor center conductor 512. The center conductor 512 may be a single conductor or a twisted pair of signal conductors. One or more twisted pair signal conductors 514 may be helically wrapped around the center conductor and insulated therefrom. The several embodiments may further include non twisted pair conductors, i.e. single insulated conductor wires 516 in combination with at least one twisted pair 514 or 512 as the case may be.

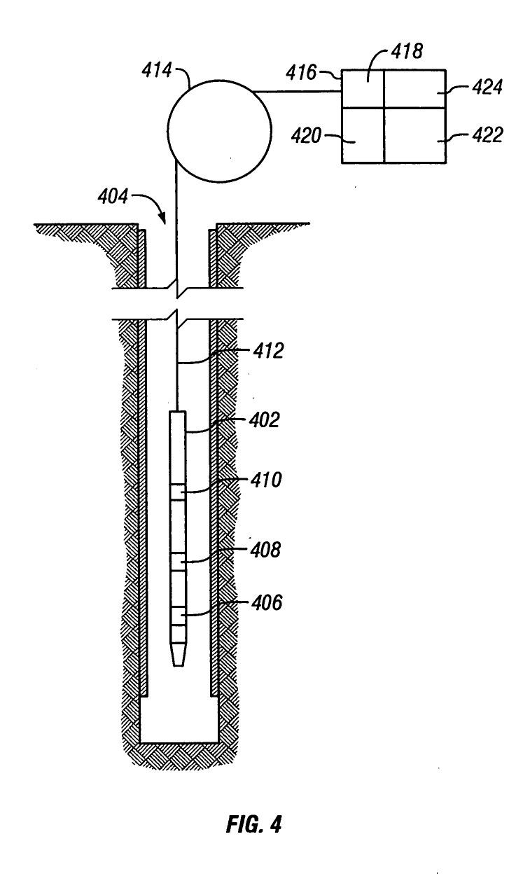

FIG. 4 is a schematic representation of a wireline system 400 according to the present invention. A tool 402 disposed in a well borehole 404 includes one or more sensors 406 for measuring parameters such as pressure, temperature, flow rate, etc.. A processor 408 is located within the tool 402 for processing and encoding data received from the sensor 406. The processor 408 is connected to a downhole modem 410. The modem 410 can be of any high data rate type used in two-conductor communication using an encoding method such as quadrature amplitude modulation (QAM), carrierless amplitude and phase (CAP) modulation, or discrete multi-tones (DMT) modulation. The tool 402 is supported by a load bearing communication cable 412 as described above in FIG. 1 or FIG. 3 depending on the application needs.

At the surface the cable is carried by a sheave and winch assembly 414, and the end of the cable 412 is connected to a surface control unit 416 comprising a surface modem 418, a processor 420, an output/storage device 422 . The surface modem is complementary to the downhole modem 410, and the processor 420 is connected to the surface modem 418 to receive, decode and process the data transmitted to the surface. The processor 420 is also used to send commands to the instruments downhole via the modem-cable-modem connection. An output device/storage 422 such as a display screen, printer, magnetic tape, CD, or the like is connected to the processor for display and/or storage of the processed data. The output device 422 may also include a transmitter 424 for relaying the processed data to a remote location.

In operation, a well engineer or user deploys the tool 402 supported by the cable 412 in the well 404 to a desired depth using the winch and sheave mechanism 414. Commands generated by user input, algorithm, or a combination are encoded at the surface using one of the methods described above. The encoded commands are then transmitted by the modem 418 through the cable 412 to the tool 402 disposed in the well. The downhole modem 410 receives the command which is then decoded for downhole operation of the tool.

When sensors 406 are activated to sense a desired parameter, the sensed parameter is delivered to the downhole processor 408 for pre-processing or sent directly to the surface. In either case, the data is encoded using one of the methods described above and transmitted by the downhole modem 410 through the cable 412 to the surface control unit 416. At the surface, the surface modem 418 receives the data. The processor 420 decodes the signal, performs further processing of the data, and the data is then displayed on a screen, printed on a printer, stored on magnetic tape, CD, or the like. The data may also be relayed to any remote location using a transmitter 424.

The foregoing description is directed to particular embodiments of the present invention for the purpose of illustration and explanation. It will be apparent, however, to one skilled in the art that many modifications and changes to the embodiment set forth above are possible without departing from the scope of the invention and the following claims.

1. A suspended well logging cable comprising:
a) an outer protective sheath;
b) a tensile load carrier positioned within the outer protective sheath, the tensile load carrier enabling the self support of the well logging cable while suspended in a well borehole;
(c) at least one twisted pair of signal conductors positioned within the outer protective sheath, each of the conductors being separately insulated, the at least one twisted pair of signal conductors having a twist rate of at least ⅙ twist per inch.

2. The well logging cable of claim 1, wherein the at least one twisted pair of signal conductors has a twist rate of at least 8 twists per foot.

3. The well logging cable of claim 1, further comprising an insulation sheath surrounding the at least one twisted pair of conductors.

4. The well logging cable of claim 1, wherein the at least one twisted pair of signal conductors comprise at most seven twisted pairs of signal conductors.

5. The well logging cable of claim 1 further comprising a single conductor longitudinally positioned in a substantially center area of the well logging cable, wherein the at least one twisted pair of signal conductors comprises at least 6 twisted pairs of conductors disposed around the single conductor.

6. The well logging cable of claim 1, wherein the at least one twisted pair of signal conductors have an effective capacitance between the twisted pair of conductors of less than 30 pF per foot of cable length.

7. A suspended well logging system comprising:
(a) a downhole well data sensor;
(b) a downhole data transmitter;
(c) a surface data receiver; and
(d) a well logging cable linking the transmitter and the receiver, the well logging cable having an outer protective sheath, the well logging cable further including:
at least one twisted pair of signal conductors positioned within the outer protective sheath, each of the conductors being separately insulated, the at least one twisted pair of signal conductors having a twist rate of at least ⅙ twist per inch,
an insulation sheath surrounding the at least one twisted pair of signal conductors, and
a tensile load carrier surrounding the insulation sheath, the load carrier comprising a sheath of tensile load carrying filaments enabling self support of the well logging cable, the downhole well data logger and the downhole transmitter while suspended in a well borehole.

8. The well logging system of claim 7, wherein the at least one twisted pair of signal conductors has a twist rate of at least 8 twists per foot.

9. The well logging system of claim 7, wherein the transmitter and receiver each includes a signal modem complimentary to each other.

10. The well logging system of claim 9, wherein the modems utilize data encoding and decoding methods selected from the group consisting of (i) QAM, (ii) CAP, and (iii) DMT.

11. The well logging system of claim 7, wherein the tensile load carrier includes of an inner layer of wires and an outer layer of wires disposed about the inner layer of wires.

12. The well logging system of claim 11, wherein the outer layer of wires has a wire size greater than the inner layer of wires.

13. The well logging system of claim 7, wherein the cable has seven twisted pairs of insulated conductors within the insulation sheath.

14. A system as described by claim 7, wherein the sensor is selected from the group consisting of (i) a pressure sensor, (ii) a temperature sensor and (iii) a flow sensor.

15. A method of using a suspended well logging cable for transmitting a signal from within a well borehole to a surface location, the method comprising:
(a) transmitting the signal with a downhole data transmitter;
(b) conveying the signal on the suspended well logging cable linking the transmitter and to a surface receiver, the well logging cable being self-supported and having at least one twisted pair of signal conductors positioned within an outer protective sheath, each of the conductors being separately insulated, the at least one twisted pair of signal conductors having a twist rate of at least ⅙ twist per inch, an insulation sheath surrounding the twisted pair of conductors and a tensile load carrier surrounding the insulation sheath, the load carrier comprising a sheath of tensile load carrying filaments enabling self support of the well logging cable, the downhole well data logger and the downhole transmitter while suspended in the well borehole.

16. The method of 15, wherein the transmitting and receiving the signal are accomplished using complimentary signal modems.

17. A method according to claim 15, wherein the signal is encoded and decoded using decoding methods selected from the group consisting of (i) QAM, (ii) CAP, and (iii) DMT.

18. The method of claim 15, wherein the at least one twisted pair of signal conductors has a twist rate of at least 8 twists per foot.

19. The method of claim 15, wherein the at least one twisted pair of signal conductors comprise at most seven twisted pairs of signal conductors.

20. The method of claim 15, wherein the well logging cable used further comprises a single conductor longitudinally positioned in a substantially center area of the well logging cable, wherein the at least one twisted pair of signal conductors comprises at least 6 twisted pairs of conductors disposed around the single conductor.
